(19) United States
(12) Patent Application Publication
(10) Pub. No.: US 2021/0301139 A1
(43) Pub. Date: Sep. 30, 2021

(54) FILLER FOR METALLIC PAINT

(71) Applicant: TOYOTA JIDOSHA KABUSHIKI KAISHA, Toyota-shi (JP)

(72) Inventors: Akira KATO, Toyota-shi (JP); Daiki KUBOYAMA, Toyota-shi (JP); Jyunya MURAI, Nisshin-shi (JP)

(21) Appl. No.: 17/178,323

(22) Filed: Feb. 18, 2021

(30) Foreign Application Priority Data
Mar. 26, 2020 (JP) 2020-055661

(51) Int. Cl. C09C 1/00

(52) U.S. Cl. CPC C09C 1/0078; C01P 2004/20; C01P 2004/02; C01P 2004/03; C01P 2004/04; C01P 2004/80

(57) ABSTRACT

Provided is a filler for a metallic paint capable of providing high brightness and radio wave transparency at the same time. The present disclosure relates to a filler for a metallic paint and a method for producing the same. The filler for the metallic paint comprises a plate-shaped substrate formed of an inorganic insulation material; and a plurality of metal particles disposed on a surface of the substrate, wherein the metal particles are disposed at intervals, and an average particle size of the metal particles is 5 nm to 200 nm.

### CROSS REFERENCE TO RELATED APPLICATIONS

The present application claims priority from Japanese patent application JP 2020-055661 filed on Mar. 26, 2020, the entire content of which is hereby incorporated by reference into this application.

### BACKGROUND

### Technical Field

The present disclosure relates to a filler for a metallic paint and a method for producing the same.

### Background Art

A coating film formed by using a metallic paint has a surface with high brightness because of a filler contained in the coating film, and is used for a vehicle body of an automobile, a motorcycle, and the like, an interior building material and an exterior building material of which designability is required, and the like.

As a filler contained in a metallic paint, for example, JP 2008-238814 A discloses a coated steel sheet that includes a coating film using a scaly Al as a brightening agent. JP H10-158540 A discloses a silver metallic pigment in which a surface of a substrate of a powder granular pigment is coated with a silver alloy by a physical vapor deposition method.

Here, for the metallic paint, various properties are required corresponding to products to which the paint is applied in addition to the high brightness. For example, a millimeter-wave radar mounted to an automobile and the like is a device that emits a radio wave in a millimeter-wave band (radio wave of wavelength of 1 mm to 10 mm) and measures a time for being reflected by an obstacle and returning to measure a distance to the obstacle. A metallic paint used for the millimeter-wave radar is required to make a coating film excellent in metallic luster and millimeter-wave transparency. However, since the scaly Al disclosed in JP 2008-238814 A and the metal film formed on the pigment substrate disclosed in JP H10-158540 A are not transparent to the radio wave, they cannot be used for a product, such as a millimeter-wave radar, that requires radio wave transparency.

### SUMMARY

As described above, the coating film formed by using the conventional metallic paint does not have the radio wave transparency in some cases, and the range of use of the paint is restricted in some cases. Accordingly, the present disclosure provides a filler for a metallic paint capable of providing high brightness and radio wave transparency at the same time.

The inventors examined various means to solve the problem, and found that in a filler for a metallic paint, high brightness and radio wave transparency can be provided at the same time by disposing a plurality of metal particles that have a specific average particle size on a surface of a plate-shaped substrate formed of an inorganic insulation material at intervals. Thus, the inventors achieved the present disclosure.

That is, the gist of the present disclosure is as follows.

(1) A filler for a metallic paint, comprising: a plate-shaped substrate formed of an inorganic insulation material; and a plurality of metal particles disposed on a surface of the substrate, wherein the metal particles are disposed at intervals, and an average particle size of the metal particles is 5 nm to 200 nm.
(2) The filler for the metallic paint according to (1), wherein a metal constituting the metal particle is at least one selected from Ag, Al, Au, Ti, Cr, Mn, Fe, Ni, Cu, Zn, Zr, Nb, Mo, In, Co, and Sn.
(3) The filler for the metallic paint according to (2), wherein the metal constituting the metal particle is Al.
(4) The filler for the metallic paint according to any of (1) to (3), wherein the plate-shaped substrate is a mica or a glass.
(5) A method for producing the filler for the metallic paint according to any of (1) to (4), comprising disposing the plurality of metal particles on the surface of the plate-shaped substrate formed of the inorganic insulation material.

The present disclosure can provide the filler for the metallic paint capable of providing the high brightness and the radio wave transparency at the same time.

### BRIEF DESCRIPTION OF THE DRAWINGS

FIG. 1 is a cross-sectional schematic diagram illustrating one embodiment of a filler of the present disclosure;

FIG. 2 is a scanning electron microscope (SEM) image of a mica alone used as a plate-shaped substrate in Example 1;

FIG. 3 is a transmission electron microscope (TEM) image of a surface of a filler of Example 1;

FIG. 4 illustrates millimeter-wave attenuation amounts of Example 1, Comparative Example 1, and the substrate alone; and

FIG. 5 is a stereoscopic microscope image of the filler of Example 1.

### DETAILED DESCRIPTION

The following describes embodiments of the present disclosure in detail.

The present disclosure relates to a filler for a metallic paint, and the filler comprises a plate-shaped substrate and a plurality of metal particles disposed on a surface of the substrate.

The substrate used for the filler of the present disclosure has a plate shape. By the use of the plate-shaped substrate having a planar portion, brightness of the filler increases. The plate-shaped substrate is formed of an inorganic insulation material. By the use of the inorganic insulation material as the plate-shaped substrate, the filler can have radio wave transparency.

The inorganic insulation material is not specifically limited, and for example, a layered mineral can be used. The inorganic insulation material can include, for example, clay, mica, talc, sericite, glass, and calcium carbonate. Mica and glass are used in some embodiments, and mica may be used in some embodiments. The plate-shaped substrate may be used alone, or two or more plate-shaped substrates may be used in combination.

An average particle size of the plate-shaped substrate is usually 5 μm to 20 μm and may be 10 μm to 15 μm in some embodiments. In the present disclosure, the average particle size of the plate-shaped substrate is a number average particle size of major axes (maximum diameters) of the plate-shaped substrate measured by a field emission scanning electron microscope (FE-SEM).

A thickness of the plate-shaped substrate is usually 0.05 μm to 1 μm. In the present disclosure, the thickness of the plate-shaped substrate is an average value of the thicknesses at about any ten positions.

An aspect ratio (average particle size/thickness) of the plate-shaped substrate is usually 10 to 200.

The metal constituting the metal particle is not specifically limited, and can include, for example, Ag, Al, Au, Ti, Cr, Mn, Fe, Ni, Cu, Zn, Zr, Nb, Mo, In, Co, and Sn. From the aspect of having the high brightness, Ag, Al, and Cr may be used, and Al is used in some embodiments.

A shape of the metal particle is not specifically limited, and may be, for example, a spherical shape, an ellipsoid shape, a plate shape, a flaky shape, a scaly shape, a dendritic shape, a rod shape, a wire shape, and an indefinite shape.

An average particle size of the metal particles is 5 nm to 200 nm, may be 10 nm to 200 nm in some embodiments, and may also be 10 nm to 150 nm in some embodiments. With the average particle size of the metal particles of 5 nm to 200 nm, the metal particles can reflect a visible light and be transparent to a millimeter-wave, thus providing the filler with radio wave transparency. In the present disclosure, the average particle size of the metal particles is a number average particle size of major axes (maximum diameters) of the particles measured by a transmission electron microscope (TEM) observation of the filler surface. When the metal particles have the spherical shapes, the average particle size is a number average particle size of diameters of the metal particles.

The surface of the metal particle may be coated with an organic protective film. A compound that constitutes the organic protective film includes, for example, a compound having at least one functional group selected from the group consisting of a carbonyl group, a hydroxyl group, and a nitrogen atom in the molecule. The compound includes polymers, for example, polyvinylpyrrolidone, polyethylenimine, polyacrylic acid, carboxymethyl cellulose, polyacrylamide, polyvinyl alcohol, polyethylene glycol, polyethylene oxide, starch, and gelatin.

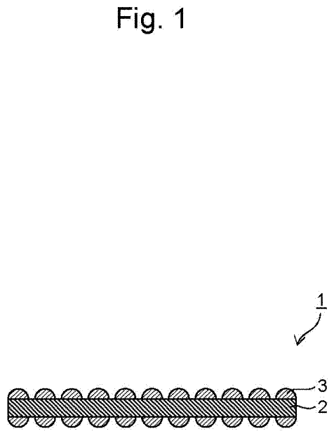

FIG. 1 is a cross-sectional schematic diagram illustrating one embodiment of the filler of the present disclosure. As illustrated in FIG. 1, a filler 1 comprises a plate-shaped substrate 2 and a plurality of metal particles 3 disposed on a surface of the plate-shaped substrate 2. The metal particles 3 are disposed at intervals. By disposing the plurality of metal particles on the surface of the plate-shaped substrate at intervals, the filler can have the radio wave transparency while ensuring the high brightness. In the filler 1, the metal particles 3 may be disposed on both surfaces of the plate-shaped substrate 2 or may be disposed on only one surface.

In the filler of the present disclosure, the plurality of metal particles are disposed on the surface of the plate-shaped substrate at intervals, that is, discontinuously disposed on the surface of the plate-shaped substrate. The intervals between the metal particles need not to be constant.

In the filler of the present disclosure, the metal particles are formed in island shapes on the surface of the plate-shaped substrate in some embodiments. That is, the metal particles are mutually independent on the plate-shaped substrate, and the metal particles are disposed in a state of being mutually slightly separated. The metal particles are not in a state where a plurality of metal particles are aggregated or a state where the metal particles are overlapped in some embodiments.

A thickness of a metal particle layer is usually 5 nm to 200 nm and may be 10 nm to 150 nm in some embodiments. The thickness of the metal particle layer can be measured by a transmission electron microscope (TEM) observation of a cross-sectional surface of the filler.

The content of the plate-shaped substrate in the filler is usually 50% by weight to 99.95% by weight relative to the total weight of the filler, and 80% by weight to 99.2% by weight in some embodiments.

The content of the metal particles in the filler is usually 0.05% by weight to 10% by weight relative to the total weight of the filler, and 0.8% by weight to 1% by weight in some embodiments.

The weight ratio between the metal particles and the plate-shaped substrate in the filler is usually 1:10 to 1:1000, and 1:100 to 1:1000 in some embodiments.

The present disclosure also includes a method for producing the filler. The method for producing the filler of the present disclosure comprises disposing a plurality of metal particles on the surface of the plate-shaped substrate formed of an inorganic insulation material.

In some embodiments, the disposing of the metal particles on the surface of the plate-shaped substrate can be performed by a method, such as a vacuum evaporation and a sputtering, or may be performed by a powder sputtering.

In the powder sputtering, for example, after introducing a powder of the plate-shaped substrate into a rotary chamber of a powder sputtering apparatus, a vacuum extraction is performed, an usually used sputtering gas, such as an argon gas, is introduced, a pressure is controlled to a range of 9×10⁻³ Pa to 9.5×10⁻³ Pa, an electric power is added to excite a plasma, and sputtering metal particle targets, thus disposing the metal particles on the plate-shaped substrate.

The powder sputtering only needs to be performed under a condition in which the metal particles are disposed at intervals and the average particle size of the metal particles is in the specific range, and for example, the thickness of the metal particle layer is controlled to 5 nm to 200 nm. The powder sputtering is performed under a condition, for example, a targeted film thickness is 2 nm to 10 nm.

In another one embodiment, the disposing of the metal particles on the surface of the plate-shaped substrate can be performed by, for example, dispersing the plate-shaped substrate in a solution containing a metal salt and a dispersing agent, heating the obtained dispersion liquid, and precipitating the metal particles on the surface of the plate-shaped substrate. The heating temperature of the dispersion liquid is usually 70° C. to 95° C. By adding a protective agent to form an organic protective film in the solution containing the metal salt and the dispersing agent, the metal particles whose surfaces are coated with the organic protective film can be precipitated on the surface of the plate-shaped substrate.

In this embodiment, the metal salt is not specifically limited, and nitrates, sulphates, acetates, and carbonates of Ag, Al, Au, Ti, Cr, Mn, Fe, Ni, Cu, Zn, Zr, Nb, Mo, In, Co, Sn, and the like can be used.

In this embodiment, the dispersing agent is not specifically limited, and for example, a polyvinylpyrrolidone can be used.

In this embodiment, the protective agent is not specifically limited, and for example, a compound that constitutes the organic protective film described above can be used.

In another one embodiment, the disposing of the metal particles on the surface of the plate-shaped substrate can be performed by using preliminarily prepared metal particles.

In this embodiment, as the metal particles, the metal particles described above can be used.

The metal constituting the metal particles is not specifically limited, and can include, for example, Ag, Al, Au, Ti, Cr, Mn, Fe, Ni, Cu, Zn, Zr, Nb, Mo, In, Co, and Sn. From the aspect of having high brightness, Ag, Al, and Cr is used in some embodiments, and Al may be used in some embodiments.

The shape of the metal particle is not specifically limited, and may be, for example, a spherical shape, an ellipsoid shape, a plate shape, a flaky shape, a scaly shape, a dendritic shape, a rod shape, a wire shape, and an indefinite shape.

The average particle size of the metal particles is 5 nm to 200 nm, and is 10 nm to 200 nm in some embodiments, or may be 10 nm to 150 nm in some embodiments.

In this embodiment, the metal particles whose surfaces are coated with the organic protective film may be used. When the metal particles coated with the organic protective film are used, coating of the metal particles with the organic protective film can be performed by a method known to those skilled in the art.

In this embodiment, for example, by treating the plate-shaped substrate with the dispersion liquid of the metal particles, the metal particles can be disposed on the surface of the plate-shaped substrate. Specifically, the pH of the dispersion liquid of the metal particles is controlled to the pH at which the zeta potential has opposite signs between the metal particles and the plate-shaped substrate, and the plate-shaped substrate is added to this dispersion liquid, thereby allowing the disposing of the metal particles on the surface of the plate-shaped substrate. In this embodiment, the metal particles coated with the organic protective film are used in some embodiments.

Since the filler of the present disclosure can provide the high brightness and the radio wave transparency at the same time, the filler can be used for a metallic paint for a product that requires the radio wave transparency, and for example, the filler can be used for a metallic paint for a millimeter-wave radar. The metallic paint can be prepared by mixing the filler of the present disclosure with a resin, an additive, and the like constituting a matrix.

### EXAMPLES

The following further specifically describes the present disclosure using examples. However, the technical scope of the present disclosure is not limited to Examples.

### Preparation of Filler

### Example 1

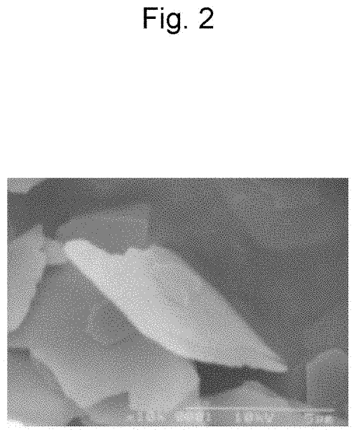

Mica (average particle size 11 μm, thickness 0.1 μm) was used as the plate-shaped substrate. FIG. 2 illustrates a scanning electron microscope (SEM) image of a mica alone used as the plate-shaped substrate.

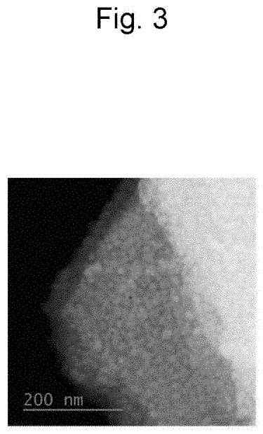

By the powder sputtering, Al particles were disposed on the surface of the mica, thus preparing the filler. The powder sputtering was performed with the targeted film thickness of 2 nm using a powder sputtering apparatus. The powder sputtering was performed under a condition of 9.4×10⁻³ Pa at room temperature. FIG. 3 is a transmission electron microscope (TEM) image of the surface of the filler taken by enlarging one of the fillers obtained in Example 1. As illustrated in FIG. 3, a plurality of Al particles were formed in island shapes on the surface of the mica, and intervals were provided between the respective Al particles. A number average particle size of major axes of the Al particles measured by the TEM was about 10 nm.

### <Evaluation>

### Millimeter-Wave Transparency

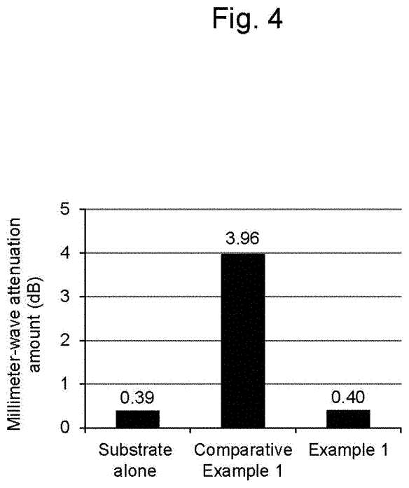

The filler of Example 1, an acrylic resin, and an isocyanate were mixed to prepare a metallic paint. The obtained metallic paint was applied over the substrate and dried, thus forming a coating film on the substrate. Millimeter-wave attenuation amount of the substrate on which the coating film was formed was measured. As a comparative example, a substrate (Comparative Example 1) over which a conventional metallic paint was applied was prepared. As the conventional metallic paint, the one that contains high brightness Al flakes, an acrylic resin, and an isocyanate was used. The millimeter-wave attenuation amount was obtained by performing one-way attenuation measurement using a millimeter-wave characteristic measurement device that includes a horn antenna and doubling the obtained measurement value. Specifically, a measurement sample was irradiated with a millimeter wave from the horn antenna on a transmitting side, and a strength of the millimeter wave that passed through the sample to enter a horn antenna on a receiving side was measured, thus deciding the one-way attenuation. A distance between the horn antennas on the transmitting side and the receiving side was 95 cm. The sample was installed such that an elevation angle with respect to the horn antenna on the transmitting side was 17° and a distance between the sample and the horn antenna on the transmitting side was about 40 mm. FIG. 4 illustrates the millimeter-wave attenuation amount of Example 1, Comparative Example 1, and the substrate alone. In FIG. 4, the smaller the value of the millimeter-wave attenuation amount is, the more excellent the millimeter-wave transparency is. As illustrated in FIG. 4, in Example 1 using the filler of the present disclosure, the millimeter-wave transparency is significantly improved compared with Comparative Example 1 using the conventional metallic paint. The approximately equivalent millimeter-wave transparency was indicated in the comparison with the substrate alone.

### Brightness

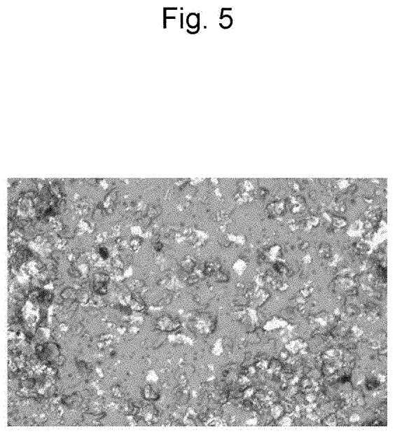

FIG. 5 is a stereoscopic microscope image of a plurality of fillers obtained in Example 1. As illustrated in FIG. 5, the filler of Example 1 has a high brightness, and the excellent metallic luster was indicated.

All publications, patents, and patent applications cited herein are incorporated herein by reference in their entirety.

### DESCRIPTION OF SYMBOLS

1 Filler
2 Plate-shaped substrate
3 Metal particle

What is claimed is:

1. A filler for a metallic paint, comprising:
a plate-shaped substrate formed of an inorganic insulation material; and
a plurality of metal particles disposed on a surface of the substrate,
wherein the metal particles are disposed at intervals, and an average particle size of the metal particles is 5 nm to 200 nm.

2. The filler for the metallic paint according to claim 1, wherein a metal constituting the metal particle is at least one selected from Ag, Al, Au, Ti, Cr, Mn, Fe, Ni, Cu, Zn, Zr, Nb, Mo, In, Co, and Sn.

3. The filler for the metallic paint according to claim 2, wherein the metal constituting the metal particle is Al.

4. The filler for the metallic paint according to claim 1, wherein the plate-shaped substrate is a mica or a glass.

5. A method for producing the filler for the metallic paint according to claim 1, comprising disposing the plurality of metal particles on the surface of the plate-shaped substrate formed of the inorganic insulation material.
